(19) United States
(12) Patent Application Publication
(10) Pub. No.: US 2007/0295440 A1
(43) Pub. Date: Dec. 27, 2007

(54) Surface roughness reduction for improving bonding in ultrasonic consolidation rapid manufacturing

(76) Inventors: Brent E. Stucker, River Heights, UT (US); Durga Janaki Ram Gabbita, Logan, UT (US)

Correspondence Address: THORPE, NORTH & WESTERN, LLP, 8180 S. 700 E., SUITE 350, SANDY, UT, 84070, US

(21) Appl. No.: 11/807,356

(22) Filed: May 24, 2007

Related U.S. Application Data
(60) Provisional application No. 60/808,638, filed on May 24, 2006.

(51) Int. Cl. B32B 37/00

(52) U.S. Cl. 156/73.1; 156/580.1

(57) ABSTRACT

A method for enhancing the bonding and linear weld density along the interface of material layers deposited in accordance with an ultrasonic consolidation manufacturing process, the method comprising: initiating an ultrasonic consolidation manufacturing process; depositing a first material layer having a contact surface; reducing surface roughness of the contact surface to prepare the contact surface to receive a subsequent material layer, the step of reducing facilitating an increased percentage and quality of material contact between the first and subsequent material layers; and bonding a subsequent material layer to the contact surface of the first material layer, as prepared.

### RELATED APPLICATIONS

This application claims the benefit of U.S. Provisional Application No. 60/808,638, filed May 24, 2006, and entitled, “Surface Roughness Reduction for Improving Bonding in Ultrasonic Consolidation Rapid Manufacturing,” which is incorporated by reference in its entirety herein.

### GOVERNMENT SUPPORT CLAUSE

This invention was made with support from the United States Government, and the United States Government may have certain rights in this invention pursuant to #DMI 0522908 sponsored by the National Science Foundation.

### FIELD OF THE INVENTION

The present invention relates generally to rapid manufacturing processes, and more particularly to a method for enhancing the metallurgical bonding and linear weld density that occurs at the interface between material layers (and/or individual material strips used to form the material layers) deposited onto one another to construct a product or part in accordance with an ultrasonic consolidation rapid manufacturing process.

### BACKGROUND OF THE INVENTION AND RELATED ART

Digitally driven or additive manufacturing methodologies have become increasingly significant in various manufacturing industries. Generally speaking, additive manufacturing comprises automated techniques for creating parts directly from digital data, such as a computer-aided-design (CAD) model. The CAD model comprises a digital representation of the part to be fabricated, and functions as a template for the digital manufacturing of the resulting part. By first constructing one or more CAD models, designers and manufacturers are able to easily create, customize, and reconfigure the part based on these models. In addition, because of the advantages provided by additive manufacturing techniques, when parts are required to be customized or reconfigured, manufacturers may modify the digital data representative of the part to be fabricated. These changes may be reflected in a newly generated CAD model.

Another benefit of using digital data, such as a CAD, system with additive manufacturing techniques is that any errors may be identified early on in the CAD model and corrected prior to manufacture of the actual part. This is a major advantage over more traditional design and methodologies, wherein a separate mock-up model of the part may be required for planning and design purposes. Obviously, however, this requires significant cost and time to complete.

Additive manufacturing systems utilize the approach of fabricating parts in a programmed layer-by-layer sequence. Once the CAD models of the parts to be fabricated are constructed, these models are then taken and digitally sliced into thin layers or cross-sections. These layers represent corresponding horizontal material layers or cross-sections of the part that are then systematically created from bottom to top producing a three-dimensional object during the manufacturing process until a complete part has been formed. Each material layer created typically comprises a plurality of deposited material strips.

Additive manufacturing has many general benefits over traditional, subtractive manufacturing techniques or methods. These include geometric, material and cost benefits. From a geometric standpoint, an additive approach enables the fabrication of structures not possible with traditional manufacturing methods, including enclosed volumes, internal passageways, and encapsulated objects. With additive manufacturing techniques, there are indeed few geometric limitations.

Furthermore, additive manufacturing techniques have several cost advantages over traditional manufacturing techniques. For low-volumes, additive manufacturing techniques are less expensive than traditional techniques for fabricating parts due to the lack of tooling and human intervention necessary. In addition, additive manufacturing facilitates various manufacturing efficiencies. What tasks may have previously taken several months to complete with traditional techniques, additive manufacturing enables the same tasks to be completed in only days by eliminating a significant portion of labor-intensive conventional machining.

One particularly capable additive manufacturing technique, known as ultrasonic consolidation, initially developed by Solidica Inc., USA, utilizes the principles of ultrasonic welding for fabricating complex three-dimensional structures from metal foils. The process uses a high frequency ultrasonic energy source to induce combined static and oscillating shear forces within metal foils to produce solid-state bonds at the interface between the layers, and to build up the rough part shape.

Ultrasonic consolidation combines the advantages of additive and subtractive fabrication approaches allowing complex 3-D parts to be formed with high dimensional accuracy and surface finish, including objects with complex internal passageways, objects made up of multiple materials, and objects integrated with wiring, fiber optics, sensors and instruments. Because the process does not involve melting, one need not worry about dimensional errors due to shrinkage, residual stresses and distortion in the finished parts. With recent advances in ultrasonic consolidation technology, fully functional metal structures can be formed at ambient or near room temperatures under highly localized plastic flow, thus making possible the embedding and encapsulation of critical components without worrying about elevated temperature affects on those components. For example, the elevated temperatures inherent in conventional metal-based additive manufacturing processes that utilize molten metal during processing damage or destroy most critical components of interest for embedding, such as circuitry, sensors, and/or actuators.

Despite its many advantages, some problems exist in current ultrasonic consolidation manufacturing methods or techniques. One particular problem affecting the integrity, strength, and overall quality of parts fabricated using an ultrasonic consolidation process is the deficient bonding that takes place at the interface between material layers, or material strips forming the material layers. It is well known that during ultrasonic consolidation processing, 100% bonding does not normally occur. Instead, metal-to-metal bonds are established at a number of points along the interface between the material layers. Close inspection of the several layer interfaces may reveal metal-to-metal bonded regions, but also oxide accumulated regions, and various physical discontinuities (no-contact regions) along the layer interfaces, which are essentially unbonded areas representing defects in the bonding. These defects are highly detrimental to mechanical and corrosion part performance.

A parameter called “linear weld density (LWD)” is generally used to represent the proportion or percentage of bonded area to unbonded area along the interface, which is a fundamental quality or attribute of ultrasonically consolidated parts. It is desirable to ensure as high a LWD as possible in ultrasonically consolidated parts, especially for load-bearing structural applications.

Unbonded areas or defects during an ultrasonic consolidation process that result in a less than 100% LWD along the interfaces of material layers, may arise due to one or more factors, such as lack of complete contact between mating surfaces due to surface roughness, persistence of surface oxide layers preventing intimate nascent metal contact, and/or accumulation of removed surface oxides at localized regions along the interface.

Defect incidence is known to be closely related to process parameters. By optimizing the process parameters as much as possible for any one given manufacturing session, one can promote increased bond formation at the material layer interfaces, and therefore increased LWD. Generally, parameter optimization such as use of relatively higher oscillation amplitude and normal force, use of relatively lower welding speeds, and use of elevated substrate temperatures are desirable for ensuring a high level of LWD in ultrasonically consolidated parts.

While it is possible to achieve good LWD in ultrasonically consolidated parts with proper parameter optimization, this approach has certain limitations. First, very low welding speeds significantly increase build time and overall cost of part fabrication. Second, elevated substrate temperatures put severe limitations on process capabilities. For example, parts with embedded electronics or other temperature-sensitive devices cannot be fabricated employing elevated substrate temperatures. Finally, use of high oscillation amplitude and/or normal force in combination with low welding speed can be damaging to the sonotrode. This may necessitate frequent sonotrode cleaning or replacement. More importantly, the severe processing conditions can lead to excessive work hardening and fatigue at the material layer interfaces, which could hamper bond strength and overall part mechanical properties.

Indeed, while parameter optimization certainly helps minimize defect formation, the defects cannot be eliminated all together. As such, one cannot rely entirely on process parameters for ensuring optimal LWI percentage in ultrasonically consolidated parts, particularly when economic influences are present. In light of this, parameter optimization, as currently known, does not represent a complete solution.

### SUMMARY OF THE INVENTION

In light of the problems and deficiencies inherent in the prior art, the present invention seeks to overcome these by providing a method for enhancing the bonding and linear weld density between material layers deposited in accordance with an ultrasonic consolidation manufacturing process.

In accordance with the invention as embodied and broadly described herein, the present invention features a method for enhancing the bonding and linear weld density along the interface of material layers deposited in accordance with an ultrasonic consolidation manufacturing process, the method comprising: (a) initiating an ultrasonic consolidation manufacturing process; (b) depositing a first material layer having a contact surface onto a base layer; (c) bonding the first material layer to the base layer; (d) reducing the surface roughness of the contact surface to prepare the contact surface to receive a subsequent material layer, the step of reducing facilitating an increased percentage and quality of material contact between the first and subsequent material layers; and (e) bonding a subsequent material layer to the contact surface of the first material layer, as prepared.

The present invention also features a method for enhancing the bonding and linear weld density along the interface of material layers deposited in accordance with an ultrasonic consolidation manufacturing process, the method comprising: (a) initiating an ultrasonic consolidation manufacturing process; (b) depositing a first material layer having a contact surface onto a base layer; (c) bonding the first material layer to the base layer; (d) removing a portion of material from the first material layer to reduce the surface roughness of the contact surface, and to prepare the contact surface to receive a subsequent material layer, the step of removing facilitating an increased percentage and quality of material contact between the first and subsequent material layers; (e) depositing a subsequent layer over the contact surface, as prepared; and (f) transmitting ultrasonic vibrations to the subsequent layer to cause the first and subsequent material layers to consolidate and bond to one another.

The present invention further features, within an ultrasonic consolidation manufacturing process, a method for removing surface roughness of a deposited material layer, the method comprising: (a) depositing a material layer over a base layer; (b) initiating an ultrasonic consolidation manufacturing process to bond the material layer to the base layer; (c) determining surface roughness of the deposited material layer; (d) initiating a process sufficient to reduce the surface roughness from the deposited material layer; (e) depositing a subsequent material layer over the deposited material layer; and (f) resuming the ultrasonic consolidation manufacturing process to cause the subsequent material layer to bond the just deposited material layer.

The present invention further features a method for fabricating a part in accordance with an ultrasonic consolidation manufacturing process, the method comprising: (a) initiating an ultrasonic consolidation manufacturing process; (b) depositing a first material layer having a contact surface; (c) removing a sufficient portion of material from the first material layer to reduce surface roughness of the contact surface, and to prepare the contact surface to receive a subsequent material layer, the step of removing facilitating an increased percentage and quality of material contact between the first and subsequent material layers; (d) bonding a subsequent material layer to the contact surface of the first material layer, as prepared; and (e) optimizing various process parameters of the ultrasonic consolidation process to achieve efficient fabrication of the part.

The present invention further features an ultrasonic consolidation manufacturing system configured to fabricate a part in accordance with an ultrasonic consolidation process, the system comprising: (a) a digital data source comprising a digital representation or model of the part to be fabricated; (b) a support structure configured to support a plurality of deposited material layers; (c) an excitation source operable with the digital data source and configured to systematically transmit ultrasonic vibrations to one or more respective contact surfaces of the deposited material layers, the excitation source being configured to cause the material layers to consolidate and bond directly to one another to build the part in accordance with the digital model; and (d) means for reducing the surface roughness of the contact surfaces of the deposited material layers, sequentially, prior to deposition of a subsequent material layer thereon and bonding thereto to enhance the bonding and to increase the linear weld density along a respective interface of the material layers.

### BRIEF DESCRIPTION OF THE DRAWINGS

The present invention will become more fully apparent from the following description and appended claims, taken in conjunction with the accompanying drawings. Understanding that these drawings merely depict exemplary embodiments of the present invention they are, therefore, not to be considered limiting of its scope. It will be readily appreciated that the components of the present invention, as generally described and illustrated in the figures herein, could be arranged and designed in a wide variety of different configurations. Nonetheless, the invention will be described and explained with additional specificity and detail through the use of the accompanying drawings in which:

FIG. 1 illustrates a perspective view of an exemplary conventional ultrasonic consolidation process;

FIG. 2 illustrates a detailed, cross-sectional side view (taken longitudinally) of a section of a substrate or part manufactured in accordance with the exemplary ultrasonic consolidation process and system shown in FIG. 1, without the benefit of the present invention surface roughness reduction method or technique;

FIG. 3 illustrates another detailed, cross-sectional side view (taken longitudinally) of a section of a substrate or part manufactured in accordance with the exemplary ultrasonic consolidation process and system shown in FIG. 1, without the benefit of the present invention surface roughness reduction method or technique;

FIG. 4 illustrates still another detailed, cross-sectional side view (taken longitudinally) of a section of a substrate or part manufactured in accordance with the exemplary ultrasonic consolidation process and system shown in FIG. 1, without the benefit of the present invention surface roughness reduction method or technique;

FIG. 5 illustrates still another detailed, cross-sectional side view (taken longitudinally) of a section of a substrate or part manufactured in accordance with the exemplary ultrasonic consolidation process and system shown in FIG. 1, without the benefit of the present invention surface roughness reduction method or technique;

FIG. 6 illustrates a flow diagram of an exemplary method for fabricating a part in according with an ultrasonic consolidation process in accordance with one exemplary embodiment of the present invention;

FIG. 7 illustrates a detailed, cross-sectional side view (taken longitudinally) of a section of a substrate or part manufactured in accordance with an exemplary ultrasonic consolidation process utilizing the present invention surface roughness reduction technique;

FIG. 8 illustrates another detailed, cross-sectional side view (taken longitudinally) of a section of a substrate or part manufactured in accordance with an exemplary ultrasonic consolidation process utilizing the present invention surface roughness reduction technique; and

FIG. 9 illustrates still another detailed, cross-sectional side view (taken longitudinally) of a section of a substrate or part manufactured in accordance with an exemplary ultrasonic consolidation process utilizing the present invention surface roughness reduction technique.

### DETAILED DESCRIPTION OF EXEMPLARY EMBODIMENTS

The following detailed description of exemplary embodiments of the invention makes reference to the accompanying drawings, which form a part hereof and in which are shown, by way of illustration, exemplary embodiments in which the invention may be practiced. While these exemplary embodiments are described in sufficient detail to enable those skilled in the art to practice the invention, it should be understood that other embodiments may be realized and that various changes to the invention may be made without departing from the spirit and scope of the present invention. Thus, the following more detailed description of the embodiments of the present invention is not intended to limit the scope of the invention, as claimed, but is presented for purposes of illustration only and not limitation to describe the features and characteristics of the present invention, to set forth the best mode of operation of the invention, and to sufficiently enable one skilled in the art to practice the invention. Accordingly, the scope of the present invention is to be defined solely by the appended claims.

The following detailed description and exemplary embodiments of the invention will be best understood by reference to the accompanying drawings, wherein the elements and features of the invention are designated by numerals throughout.

Three distinct types of defect morphologies can be seen in ultrasonically consolidated parts, namely line-like defects, parabola-like defects, and point-like defects. All the three types of defects can be present, at least to some extent, in all the material layer deposits. However, process parameters, as discussed above, determine the predominant type of defects that form in a part. From a fracture mechanics standpoint, line-like defects are most likely more detrimental to mechanical properties than parabola-like or point-like defects.

Generally speaking, the present invention describes a method and system for enhancing the bonding and linear weld density (LWD) along the interface of material layers deposited in accordance with an ultrasonic consolidation manufacturing process. The method comprises reducing the surface roughness of a just deposited material layer prior to depositing a subsequent material layer and bonding these material layers together. By reducing surface roughness, the presence of many of the above-identified defects or defect morphologies may be significantly reduced, lessened, or eliminated. At the very least, the size and dimensions of defects may be reduced.

Surface roughness reduction may mean either partial or complete removal of surface roughness. It is contemplated that reduction of surface roughness to any degree will enhance bonding and the formation of such bonding, as well as to improve the LWD between material layers. As such, the present invention is not limited to completely removing surface roughness, although such will most likely be preferred. Indeed, reducing surface roughness may comprise only partially removing surface roughness, which will still positively impact the bonding and LWD at the interface between material layers. It is foreseeable that partial removal of surface roughness may be permitted, as constrained or limited by the particular part or product being fabricated or other factors. Those skilled in the art will recognize other conditions where less than complete removal of surface roughness may be desirable.

The present invention provides several significant advantages over prior related ultrasonic consolidation processes or methodologies, some of which are recited here and throughout the following more detailed description. Indeed, many advantages are realized by providing a method for preparing the contact surface of just deposited material layers and/or strips prior to depositing a subsequent material layer or strip, wherein the preparation of the contact surface involves removing at least a portion of material making up the contact surface of the material layer, thus in effect, creating a new, or at least an improved, contact surface wherein any defects are reduced in dimension or eliminated. First, the present invention methods function to identify and eliminate, as much as possible, defects in the contact surface of the material layers during the ultrasonic consolidation process. Second, the present invention methods improve the quality of parts or products formed from an ultrasonic consolidation process by enhancing the bonding between the material layers making up the parts or products. Third, the process window for satisfactory part fabrication is widened or expanded. Fourth, process parameters may be optimized for efficiency of part fabrication rather than for optimization of linear weld density. Therefore, part fabrication may be conducted at significantly higher welding speeds and/or at increased ambient temperatures without compromising overall linear weld density. Fifth, the use of process parameter selections that lead to excessive work hardening and/or fatigue-related effects at the interface can be avoided. Sixth, the present invention methods are simple and easily implemented without modification to existing ultrasonic consolidation equipment.

Each of the above-recited advantages will be apparent in light of the detailed description set forth below, with reference to the accompanying drawings. These advantages are not meant to be limiting in any way. Indeed, one skilled in the art will appreciate that other advantages may be realized, other than those specifically recited herein, upon practicing the present invention.

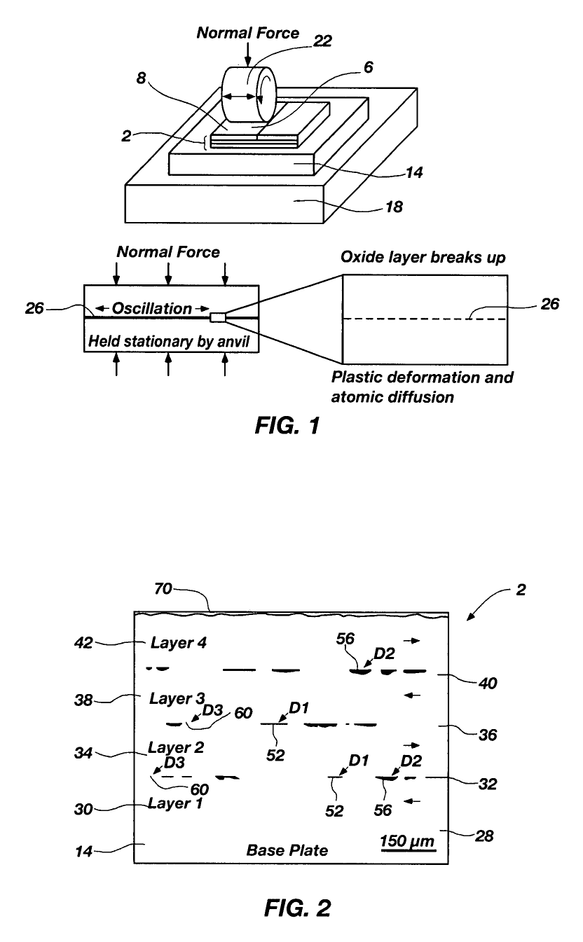

With reference to FIG. 1, and generally speaking, illustrated is an exemplary ultrasonic consolidation process in which the present invention may be implemented. In this embodiment, part fabrication takes place on a firmly bolted base plate 14 (typically of the same material as the material layers being deposited) supported on the top of a heat plate 18. The heat plate 18 functions to maintain a substrate (a previously deposited material layer or layers) 2 at a desired temperature allowing the deposition process to be carried out at temperatures ranging from ambient to 350° F.

An excitation source, shown as a rotating ultrasonic consolidation head in the form of a sonotrode 22 travels along the length of a thin foil or material strip 8 that is part of a deposition layer (the layer currently being deposited or added) 6, and that is placed over the substrate 2. The thin material strip 8 is held closely in contact with the substrate 2 by applying a normal force via the rotating sonotrode 22.

The sonotrode 22 oscillates transversely to the direction of welding at a desired frequency, for example 20 kHz, and at a set oscillation amplitude, while traveling over the material strip 8. The combination of normal and oscillating shear forces results in generation of dynamic interfacial stresses at the interface between the two mating surfaces of the material strip 8 (the deposition layer 6) and the substrate 2. The interfacial stresses, and resulting friction, cause local elastic-plastic deformation of surface asperities within a deformation or weld zone 26, which breaks up surface oxides, producing relatively clean metal surfaces, across which atomic diffusion takes place, thus establishing a metallurgical bond between the material strip 8 and the substrate 2. Oxides or oxide films broken up during the process are displaced in the vicinity of the interface or along the deformation zone 26.

The affected material thickness t is typically on the order of micrometers, generally between 50 and 500 μm thick. Moreover, the temperature rise between the materials is below the melting point of the materials, and the rise in overall bulk material temperature is minimal, typically being only a few degrees Celsius, thus being substantially below the melting point of the materials. Advantageously, throughout the process the mechanical properties of the materials are for the most part preserved.

After depositing a material strip, another material strip is deposited adjacent to the one just deposited. This process repeats until a complete deposition or material layer is formed. After placing a material layer, a computer controlled milling head may be initiated to shape the layer to its slice contour. This milling can occur after each deposited material layer or, for certain geometries, after several material layers have been deposited. Once the material layer is shaped to its contour, the residue is removed and material strip deposition starts for a subsequent material layer. The process repeats as often as needed to form the material layers of the fabricated part.

Ultrasonic consolidation provides the ability to form structures or parts from metals, plastics, ceramics, and combinations thereof, each of which are contemplated to benefit from the present invention surface roughness reduction. The compositions of these materials may vary discontinuously or gradually from one layer to the next. Plastic or metal matrix composite materials incorporating reinforcement materials of various compositions and geometries may also be used. In particular, metal foils may be used, such as aluminum foils. Many different types of metal materials, and alloys of these, whether foil or not, are contemplated for use herein, such as aluminum, titanium, steel, silver, copper, magnesium, and others, although the most common may be aluminum and aluminum alloys.

It is noted that various exemplary ultrasonic consolidation processes and methodologies are described at length in U.S. Pat. No. 6,519,500, issued on Feb. 11, 2003 to White; U.S. Pat. No. 6,463,349, issued on Oct. 8, 2002 to White; and U.S. Pat. No. 6,457,629, issued on Oct. 1, 2002 to White, each of which are incorporated by reference in their entirety herein.

FIG. 2 illustrates a detailed, cross-sectional side view (taken longitudinally) of a section of a substrate 2 manufactured in accordance with the exemplary ultrasonic consolidation process and system described above and shown in FIG. 1, without the benefit of the present invention surface roughness reduction method or technique. As shown, the substrate 2 comprises a plurality of material layers deposited on top of one another, shown as first material layer 30, second material layer 34, third material layer 38, and fourth material layer 42, wherein first material layer 30 is deposited over a base plate 14. FIG. 2 also illustrates the interfaces between the several material layers. Specifically, FIG. 2 illustrates interface 28 between base plate 14 and first material layer 30, interface 32 between first material layer 30 and second material layer 34, interface 36 between second material layer 34 and third material layer 38, and interface 40 between third material later 38 and fourth material layer 42.

Located at the interfaces 28, 32, 36, and 40 are a plurality of defects, namely the morphological defects described above. Specifically, FIG. 2 illustrates a plurality of line-like defects 52, parabola-like defects 56, and point-like defects 60. These defects are the result of the ultrasonic consolidation manufacturing process, as conventionally understood, and represent unbonded areas between the respective material layers contributing to a less than optimal LWD, wherein such an optimal LWD may range between 98 and 100%. Any one or more sources including lack of complete contact between mating surfaces due to surface roughness, persistence of surface oxide layers preventing intimate nascent contact, and/or accumulation of removed surface oxides at localized regions along the interface may contribute to or cause these defects.

Out of the three sources mentioned, surface roughness is perhaps the most problematic, and the one contributing the greatest to the manifestation and number of defects along the material layer interfaces. During conventional ultrasonic consolidation processes, while depositing a material layer or strip, sonotrode motion on the layer or strip can result in a very rough surface having various sized and shaped peaks and valleys. FIG. 2 illustrates several peaks and valleys formed in the contact surface 70 of the last deposited fourth material layer 42. As can be seen, the surface of the fourth layer 42 is very rough with the amplitude between some of the peaks and valleys (the surface roughness) reaching as much as 10-15 microns or more. Similar surface roughness would have been present on each of the first, second, and third material layers 30, 34, and 38, respectively, after each was deposited and prior to deposition of a subsequent material layer.

However, as can be seen in FIG. 2, there are no, or at the most negligible, defects at the interface 28 between the base plate 14 and the first material layer 30. As such, the first material layer 30 is well bonded to the base plate 14 with a substantially 100% LWD compared to the other interfaces between the other layers. It is contended that this relatively high LWD may be attributed to the configuration of the base plate 14, which is surface machined just prior to part fabrication in order to ensure a flat, leveled platform for part fabrication.

One possible reason for the enhanced bond formation between the base plate 14 and the first material layer 30 may be the absence of a surface oxide layer on the base plate 14, as such oxide layer was likely removed as a result of the surface machining process. While the absence of an oxide layer may enhance bond formation to some degree, this, without more, cannot satisfactorily explain the high LWD as the subsequently deposited material layer still has a surface oxide layer, which would negatively impact the bonding between these two materials.

Another important difference between the base plate 14 and the subsequently deposited first material layer 30 is the surface roughness of the base plate 14. Due to the surface machining undergone, the base plate 14 comprises a flat, even or smooth surface. It is contemplated that the smooth surface resulting from the surface machining process facilitates effective surface contact between the mating surfaces of the base plate 14 and the first material layer 30, resulting in excellent bond formation between the two.

In contrast, while depositing a material layer, sonotrode motion on the material layer can result in a very rough surface with hills and valleys, as can be seen on the surface 70 of the fourth material layer 42 in FIG. 2. The surface roughness of the material layers is therefore negatively increased by the ultrasonic consolidation process, and particularly the motion of the sonotrode about the surface of the material layer being deposited. Since the base plate 14 is never subjected to the sonotrode, its surface remains smooth and devoid of significant surface roughness.

It is further contended that the sonotrode-induced roughness on the surface of the deposited material layer functions to prevent effective surface contact during subsequent layer deposition as the regions along the interface corresponding to valleys can manifest into defects. This contention is supported by the occurrence of parabola-like defects with flat top and curved bottom, shown as defects 56, whose size closely match with the roughness scale induced on the material layer or strip surface due to sonotrode motion. Therefore, sonotrode-induced roughness is considered a major source of defects in ultrasonically consolidated parts and significant improvement in % LWD can be achieved by reducing the sonotrode-induced surface roughness on the just deposited material layer/strip surface prior to subsequent layer deposition.

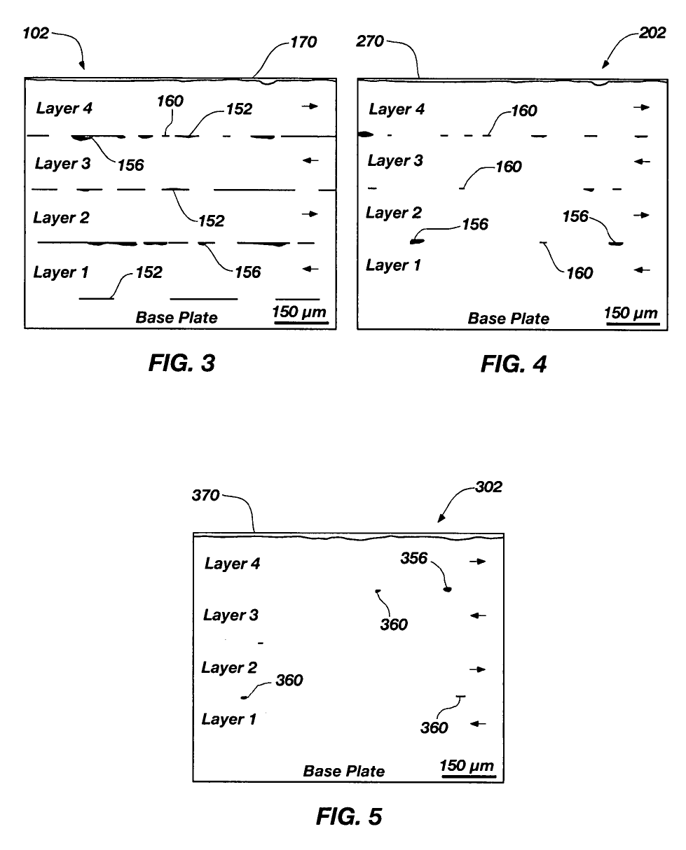

As indicated above, varying process parameters of an ultrasonic consolidation manufacturing process can affect the resulting LWD between material layers. Although all types of defects can be manifested at least to some extent in the interfaces between the material layer deposits, it is known that process parameters can determine the predominant type of defects that form in a particular fabricated part. FIG. 3 illustrates a detailed, cross-sectional side view (taken longitudinally) of a section of a substrate 102 manufactured in accordance with the exemplary conventional ultrasonic consolidation process and system described above and shown in FIG. 1, again without the benefit of the present invention surface roughness reduction method. In the process used to fabricate this part, process parameters were as follows: amplitude—10 microns, welding speed—28 mm/s, applied force—1450 N, temperature of the substrate—75° F. As shown, the predominant defects in this particular substrate 102 occurring as a result of these process parameters are line-like defects 152. However, parabola-like defects 156 and point-like defects 160 are also present, although in smaller quantity.

FIG. 3 further illustrates the surface roughness of the contact surface 170 of the uppermost material layer. As can be seen, the contact surface 170 of this particular substrate and material layer is not as rough as that of the contact surface 70 of the substrate 2 of FIG. 2. As a result, the defects along the material layer interfaces are less pronounced as line-like defects make up a majority of the manifested defects.

FIG. 4 illustrates a detailed, cross-sectional side view (taken longitudinally) of a section of a substrate 202 manufactured in accordance with the exemplary conventional ultrasonic consolidation process and system described above and shown in FIG. 1, again without the benefit of the present invention surface roughness reduction method. In the process used to fabricate this part, process parameters were as follows: amplitude—16 microns, welding speed—28 mm/s, applied force—1750 N, temperature of the substrate—300° F. As shown, the predominant defects in this particular substrate 202 occurring as a result of these process parameters are point-like defects 260, with a small number of parabola-like defects 156.

FIG. 4 further illustrates the surface roughness of the contact surface 270 of the uppermost material layer. As can be seen, the contact surface 270 of this particular substrate and material layer is slightly rougher than the contact surface 170 of the substrate 102 of FIG. 3, yet still not as rough as that of the contact surface 70 of the substrate 2 of FIG. 2.

FIG. 5 illustrates a detailed, cross-sectional side view (taken longitudinally) of a section of a substrate 302 manufactured in accordance with the exemplary conventional ultrasonic consolidation process and system described above and shown in FIG. 1, again without the benefit of the present invention surface roughness reduction method. In the process used to fabricate this part, process parameters were as follows: amplitude—16 microns, welding speed—12 mm/s, applied force—1750 N, temperature of the substrate—300° F. As shown, the predominant defects in this particular substrate 302 occurring as a result of these process parameters are point-like defects 360 with a small presence of parabola-like defects 356. Overall, there is significantly less defects in this particular substrate as compared to those illustrated in FIGS. 3 and 4, which reduction in defects may be attributed to the process parameters used in the fabrication of the substrate. In addition, the resulting LWD is also improved over the others.

FIG. 5 further illustrates the surface roughness of the surface 370 of the uppermost material layer. As can be seen, the contact surface 370 of this particular substrate and material layer is not as rough as the contact surface 270 of the substrate 202 of FIG. 3, thus resulting in much less defects along the material layer interfaces.

As is evident from the characteristics of the various substrates depicted in FIGS. 2-5, and as is well known in the art, defect incidence is closely related to process parameters. By optimizing the process parameters to improve bond formation at the material layer interfaces, high LWD can be achieved. However, as indicated above, optimizing process parameters to improve bond formation and LWD has it limitations.

Based on the foregoing, the present invention method comprises a method for reducing the surface roughness of deposited material layers prior to deposition of a subsequent layer. By doing this, surface roughness is significantly reduced, which in turn, effectively improves the bonding at the interface between material layers to the point where substantially 100% LWD is achieved. The present invention method of reducing surface roughness further enables the optimization of process parameters to be focused on part fabrication efficiency rather than on improving LWD.

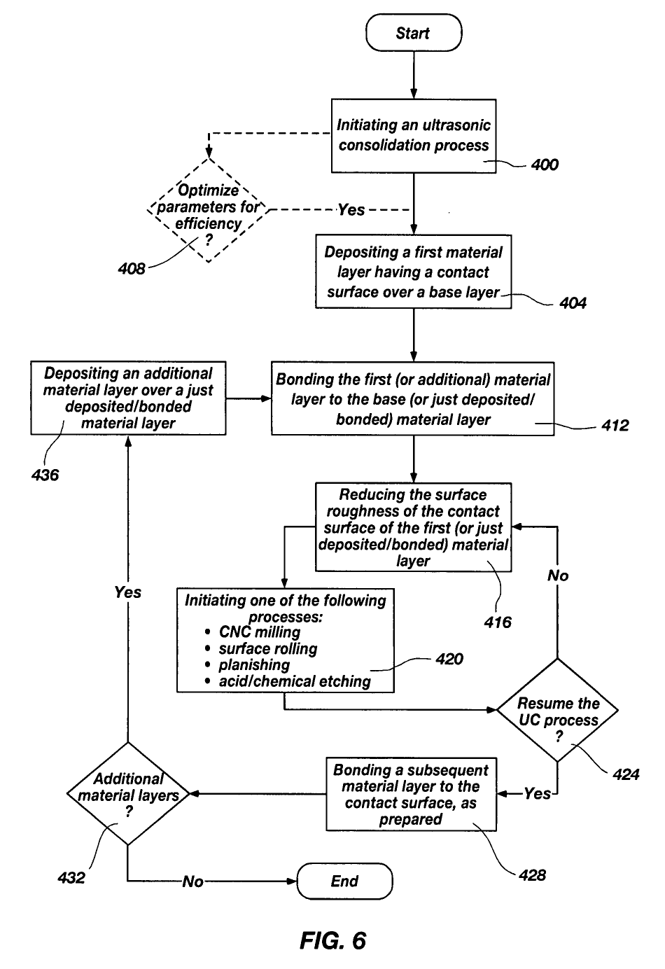

With reference to FIG. 6, illustrated is a flow diagram of one exemplary method for fabricating a part in accordance with an ultrasonic consolidation rapid manufacturing process, wherein the method and process includes steps for enhancing the bonding along the interface between material layer. As shown, the method comprises step 400, initiating an ultrasonic consolidation process. The ultrasonic consolidation process may be any such process known in the art, such as the exemplary process described above with respect to FIG. 1. However, unlike conventional ultrasonic consolidation processes where process parameters are or may be optimized to increase linear weld density between material layers, and wherein such parameter optimization for linear weld density often conflicts with the efficiency of part fabrication, the present invention, due to the incorporation of an intermediate surface reduction process/method to be applied to one or more deposited and bonded material layers used to form the part (described in more detail below), enables the focus of the ultrasonic consolidation process to be shifted to optimize process parameters for efficiency of part fabrication. And, this can be done without sacrificing performance or quality of the part as the linear weld density is actually improved over parts fabricated using conventional ultrasonic consolidation methods. As step 408 indicates, optimizing process parameters in the ultrasonic consolidation process for part fabrication efficiency is not required, but may be implemented where desired.

It is contemplated that many different actual process parameters may be optimized for part fabrication efficiency, including increasing welding speeds beyond what would otherwise be acceptable, as well as modifying other parameters. The types of process parameter optimization that may be carried out or implemented to increase part fabrication efficiency will be apparent to those skilled in the art.

The method further comprises step 404, depositing a first material layer having a contact surface over a base layer. The base layer may comprise a base plate as described above, or any just deposited layer within a substrate. The method continues with step 412, bonding the first material layer to the base layer. Bonding is achieved via the initiated ultrasonic consolidation method or process. During the ultrasonic consolidation process, and as the first material layer is bonded to the base layer, the contact surface (the uppermost surface) of the surface roughness of the first material layer is increased. The increase in surface roughness of the contact surface of the first material layer is typically a result of the depositing and bonding of the first material layer on/to the base layer effectuated by the ultrasonic consolidation process. For instance, in the exemplary ultrasonic consolidation process described above, the surface roughness is increased or induced as a result of the motion of the sonotrode about the contact surface of the first material layer, which motion causes very a rough surface having peaks and valleys, as shown in FIGS. 2-5 and discussed above. Since stock material layers typically comprise a very fine, mirror-like surface finish, it can be said that the surface roughness of the first deposited material layer is induced by the ultrasonic consolidation process, and particularly the sonotrode. Surface roughness on the first deposited material layer, no matter the cause, can prevent effective surface contact during subsequent material layer deposition and the regions corresponding to valleys can manifest into defects, also as discussed above. As such, process-induced surface roughness represents a primary source of defects in ultrasonically consolidated parts. Removal of the process-induced surface roughness on the first deposited material layer, or material strips making up the layer, prior to depositing a subsequent material layer can result in a significant improvement of percentage linear weld density along the interface between the first material layer and any subsequent material layer.

FIG. 6 further illustrates step 416, reducing the surface roughness of the contact surface of the first material layer prior to depositing a subsequent material layer on the contact surface of the first material layer. In this step, reducing the surface roughness effectively functions to prepare the contact surface to receive a subsequent material layer, as well as to increase the percentage and quality of material contact between the first and a subsequent material layer.

By reducing surface roughness prior to depositing a subsequent material layer, nearly 100% linear weld density may be achieved in parts fabricated. This is true even at significantly higher welding speeds as compared to prior ultrasonic consolidation processes. Essentially, surface roughness reduction improves the quality of the bonding between ultrasonically consolidated material layers of a part. Surface roughness reduction is effective for many reasons, including, but not limited to those discussed here. First, removal of surface roughness facilitates intimate contact between mating surfaces, leading to a significant increase in the number of surface contact points at which bonding occurs. Surface roughness reduction removes the peak and valley patterns on the contact surfaces of just deposited material layers (or strips) caused by the ultrasonic consolidation process (e.g., sonotrode motion), which peaks and valley pattern would otherwise manifest into defects. Second, surface roughness reduction completely removes the oxide layer on one of the mating surfaces during ultrasonic welding. Although surface oxides may exist on the opposing or other mating surface, this effectively reduces all problems associated with oxide layers to at least half. Third, surface roughness reduction removes the work hardened layer either completely or partially on the contact surface of the just deposited material layer, thus maximizing plastic deformation and facilitating more efficient or easier plastic flow at the interface, while minimizing surface roughness, during deposition and bonding of a subsequent layer, which state of plastic flow is an important condition in bond formation during ultrasonic consolidation.

As shown in step 420, reducing the surface roughness of the contact surface may be achieved using any known process/method, including, but not limited to, CNC machining in which a layer of material is physically machined or removed from first material layer to essentially produce a new contact surface, surface rolling in which the surface is subjected to a pressure source sufficient to flatten the contact surface and smooth the peaks and valleys, planishing, acid etching, and chemical etching. Other methods or processes suitable to reduce the surface roughness other than those identified herein will be apparent to those skilled in the art. As is apparent, it is not necessary to actually remove material from the material layer in order to effectively reduce the surface roughness of the material layer. In the event it is desirable to actually remove material from the material layer, any amount may be removed to adequately and sufficiently reduce the surface roughness. The amount or depth of material removed will largely depend upon the level or magnitude of the surface roughness, but other factors, such as costs, may be controlling or weighed. Ideally, the amount of material removal will be just adequate to remove the surface roughness completely. Excessive material removal unnecessarily increases the machining time and number of layers for part fabrication, thereby increasing the overall build time. In most instances, it is contemplated that removing an amount of material having a depth ranging between 0.5 and 40 microns, and preferably between 2 and 20 microns, will be sufficient. However, it is possible to derive the full benefits of the approach with comparatively smaller or higher material removal. As such, the depths of material removal recited here are not meant to be limiting in any way.

The removal of material may be accomplished using any type of machining system, such as a dedicated surface machining set-up annexed to the ultrasonic consolidation machine that is custom designed to enhance machining speeds and others.

Depending upon the particular part to be fabricated, and in light of other potentially relevant factors, it is further contemplated that all or only a portion of a contact surface of a material layer may be subjected to a surface roughness reduction process. As such, complete and total reduction in surface roughness of a material layer may be optional.

The step of reducing the surface roughness may be implemented into the ultrasonic consolidation process as an intermediate step, therefore modifying the ultrasonic consolidation process somewhat. In one aspect, the surface roughness reduction process step may be integrated into the overall ultrasonic consolidation process. In other words, the ultrasonic consolidation process may be modified to include a surface roughness reduction process step in accordance with the teachings herein. In doing so, the surface reduction process may be incorporated into the code of the part building sequence so that the process proceeds from one step to the next automatically. No additional modifications to the regular part building sequence of the ultrasonic consolidation process should be required.

In another aspect, the surface reduction process may comprise a separate, independent process, wherein, in order to carry out the surface reducing process, the initiated ultrasonic consolidation process may be temporarily terminated in order to initiate the surface roughness reduction process prior to depositing a subsequent material layer over the first material layer. A preferred ultrasonic consolidation process would incorporate the surface roughness reduction process so as to minimize any interruption in the overall process used to fabricate the given part.

Once the surface roughness reduction process is completed for the first layer the normal ultrasonic consolidation process may be resumed, as illustrated by step 424 in FIG. 6. However, if surface roughness has not been sufficiently reduced, the first material layer may be subjected to the same or a different surface roughness reduction process, which would involve repeating the step of reducing surface roughness as indicated by step 416.

If the initial surface roughness process was sufficient, the ultrasonic consolidation process may continue to effectively deposit and bond a subsequent material layer over the first material layer, as prepared, as illustrated in step 428.

FIG. 6 further illustrates step 432, wherein if other or additional material layers are to be deposited in the fabrication of the part, then the ultrasonic consolidation process may continue and the steps above repeated as often as necessary. As shown in FIG. 6, if additional material layers are called for, the ultrasonic consolidation process comprises step 436, depositing an additional material layer over a just deposited/bonded material layer; step 412, bonding the additional material layer to the just deposited/bonded material layer; step 416 reducing the surface roughness of the just deposited/bonded material layer; and step 428 bonding a subsequent material layer to the just deposited/bonded material layer. Each of these repeated steps will be the same or similar to those described above, thus the entire discuss for these repeating steps is not repeated herein.

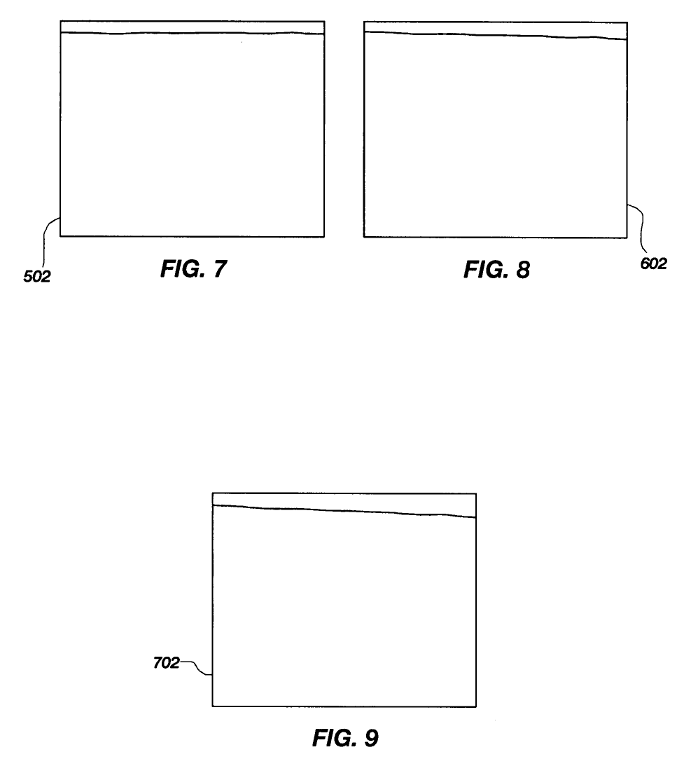

FIGS. 7-9 illustrate various partial, detailed cross-sectional side views (taken longitudinally) of a substrate or part formed in accordance with an ultrasonic consolidation process implementing a surface roughness reduction process or step as taught herein. Specifically, FIG. 7 illustrates a substrate 502 formed at a welding speed of 28 mm/s. As can be seen, nearly 100% linear weld density is achieved due to the surface reduction of the material layers making up the substrate 502. FIG. 8 illustrates a similar substrate 602 formed at a welding speed of 36 mm/s. A near 100% linear weld density is also achieved. Other parameters were held constant during the formation of each of the substrates 502 and 602, namely amplitude at 16 microns, normal force 1750 N, and substrate temperature 300° F. FIG. 9 illustrates substrate 702 formed at a welding speed of 32 mm/s in which a near 100% linear weld density is achieved. Other parameters present during formation of substrate 702 include an amplitude of 16 microns, normal force of 1750 N, and a substrate temperature of 75° F.

It is noted herein that although the present invention primarily discussed ultrasonic consolidation manufacturing processes, it is contemplated that the present invention is equally applicable to other ultrasonic welding based rapid manufacturing processes. Also, the present invention is equally applicable to ultrasonic weld processing of materials in general.

The foregoing detailed description describes the invention with reference to specific exemplary embodiments. However, it will be appreciated that various modifications and changes can be made without departing from the scope of the present invention as set forth in the appended claims. The detailed description and accompanying drawings are to be regarded as merely illustrative, rather than as restrictive, and all such modifications or changes, if any, are intended to fall within the scope of the present invention as described and set forth herein.

More specifically, while illustrative exemplary embodiments of the invention have been described herein, the present invention is not limited to these embodiments, but includes any and all embodiments having modifications, omissions, combinations (e.g., of aspects across various embodiments), adaptations and/or alterations as would be appreciated by those in the art based on the foregoing detailed description. The limitations in the claims are to be interpreted broadly based on the language employed in the claims and not limited to examples described in the foregoing detailed description or during the prosecution of the application, which examples are to be construed as non-exclusive. For example, in the present disclosure, the term “preferably” is non-exclusive where it is intended to mean “preferably, but not limited to.” Any steps recited in any method or process claims may be executed in any order and are not limited to the order presented in the claims. Means-plus-function or step-plus-function limitations will only be employed where for a specific claim limitation all of the following conditions are present in that limitation: a) “means for” or “step for” is expressly recited; and b) a corresponding function is expressly recited. The structure, material or acts that support the means-plus function are expressly recited in the description herein. Accordingly, the scope of the invention should be determined solely by the appended claims and their legal equivalents, rather than the descriptions and examples given above.

What is claimed and desired to be secured by Letters Patent is:

1. A method for enhancing the bonding and linear weld density along the interface of material layers deposited in accordance with an ultrasonic consolidation manufacturing process, said method comprising:
initiating an ultrasonic consolidation manufacturing process;
depositing a first material layer having a contact surface onto a base layer;
bonding said first material layer to said base layer;
reducing surface roughness of said contact surface to prepare said contact surface to receive a subsequent material layer, said step of reducing operating to facilitate an increased percentage and quality of material contact between said first and subsequent material layers; and
bonding said subsequent material layer to said contact surface of said first material layer, as prepared, said reducing enhancing said bond.

2. The method of claim 1, further comprising repeating said steps of reducing surface roughness and bonding a subsequent material layer for any number of material layers deposited in accordance with said ultrasonic consolidation manufacturing process to fabricate said part.

3. The method of claim 1, further comprising optimizing ultrasonic consolidation manufacturing process parameters to focus on part fabrication efficiency rather than on improving linear weld density, said step of reducing surface roughness of said contact surface prior to depositing said subsequent material layer operating to improve linear weld density.

4. The method of claim 1, wherein said material layer and said subsequent material layer each comprise a plurality of individual material strips.

5. The method of claim 1, wherein said surface roughness of said contact surface is induced by a sonotrode of said ultrasonic consolidation manufacturing process.

6. The method of claim 1, wherein said reducing surface roughness comprises removing between 0.5 and 40 microns of material from said contact surface of said first material layer.

7. The method of claim 1, wherein said reducing surface roughness comprises removing a sufficient amount of material from said contact surface of said first material to remove, at least partially, one or all of existing surface oxides, accumulated surface oxides resulting from said ultrasonic consolidation process, and a work hardened layer, thus maximizing plastic deformation and facilitating more efficient plastic flow at the interface.

8. The method of claim 1, wherein said reducing surface roughness comprises reducing only a portion of surface roughness from said contact surface.

9. The method of claim 1, wherein said reducing surface roughness comprises machining said contact surface using a CNC machining process.

10. The method of claim 1, wherein said reducing surface roughness comprises surface rolling said contact surface using a pressure source capable of applying a pressure to said contact surface sufficient to smooth said contact surface.

11. The method of claim 1, wherein said reducing surface roughness comprises planishing said contact surface.

12. The method of claim 1, wherein said reducing surface roughness comprises etching said contact surface, said etching being selected from the group consisting of acid etching, chemical etching and any combination of these.

13. The method of claim 1, wherein said reducing surface roughness is selected from the group consisting of machining, surface rolling, planishing, etching, and any combination of these.

14. The method of claim 1, wherein said step of reducing surface roughness is incorporated into said ultrasonic consolidation manufacturing process.

15. A method for enhancing the bonding and linear weld density along the interface of material layers deposited in accordance with an ultrasonic consolidation manufacturing process, said method comprising:
initiating an ultrasonic consolidation manufacturing process;
depositing a first material layer having a contact surface onto a base layer;
bonding said first material layer to said base layer;
removing a sufficient portion of material from said first material layer to reduce the surface roughness of said contact surface, and to prepare said contact surface to receive a subsequent material layer, said step of removing facilitating an increased percentage and quality of material contact between said first and subsequent material layers;
depositing said subsequent layer over said contact surface, as prepared; and
transmitting ultrasonic vibrations to said subsequent layer to cause said first and subsequent material layers to consolidate and bond to one another.

16. Within an ultrasonic consolidation manufacturing process, a method for removing surface roughness of a deposited material layer, said method comprising:
depositing a material layer over a base layer;
initiating an ultrasonic consolidation manufacturing process to bond said material layer to said base layer;
determining the surface roughness of said deposited material layer;
initiating a process sufficient to reduce said surface roughness of said deposited material layer;
depositing a subsequent material layer over said deposited material layer; and
resuming said ultrasonic consolidation manufacturing process to cause said subsequent material layer to bond said just deposited material layer.

17. The method of claim 16, wherein said substrate comprises a base plate.

18. The method of claim 16, wherein said step of initiating a process to reduce said surface roughness comprises initiating a process selected from the group consisting of CNC machining, surface rolling, planishing, acid etching, chemical etching, and any combination of these.

19. A method for fabricating a part in accordance with an ultrasonic consolidation manufacturing process, said method comprising:
initiating an ultrasonic consolidation manufacturing process;
depositing a first material layer having a contact surface onto a base layer;
bonding said first material layer to said base layer;
removing a sufficient portion of material from said first material layer to reduce surface roughness of said contact surface, and to prepare said contact surface to receive a subsequent material layer, said step of removing facilitating an increased percentage and quality of material contact between said first and subsequent material layers;
bonding said subsequent material layer to said contact surface of said first material layer, as prepared; and
optimizing various process parameters of said ultrasonic consolidation process to achieve efficient fabrication of said part.

20. An ultrasonic consolidation manufacturing system configured to fabricate a part in accordance with an ultrasonic consolidation process, said system comprising:
a digital data source comprising a digital representation or model of said part to be fabricated;
a support structure configured to support a plurality of deposited material layers;
an excitation source operable with said digital data source and configured to systematically and sequentially transmit ultrasonic vibrations to one or more respective contact surfaces of said deposited material layers, said excitation source being configured to cause said material layers to consolidate and bond directly to one another to build said part in accordance with said digital model; and
means for reducing the surface roughness of said contact surfaces of said deposited material layers prior to deposition of a subsequent material layer thereon and bonding thereto to enhance said bonding and to increase the linear weld density along a respective interface of said material layers.

21. The system of claim 20, wherein said means for reducing is selected from the group consisting of a CNC milling machine, a surface rolling machine, a planishing machine, a chemical etcher, an acid etcher, and any combination of these.

22. The system of claim 20, wherein said means for reducing is integrated directly into said ultrasonic consolidation process.

23. The system of claim 20, wherein said surface roughness is ultrasonic consolidation process-induced.
